(19) United States
(12) Patent Application Publication
(10) Pub. No.: US 2012/0307016 A1
(43) Pub. Date: Dec. 6, 2012

(54) 3D CAMERA

(75) Inventor: Yukio UENAKA, Tokyo (JP)

(73) Assignee: PENTAX RICOH IMAGING COMPANY, LTD., Tokyo (JP)

(21) Appl. No.: 13/482,243

(22) Filed: May 29, 2012

(30) Foreign Application Priority Data
May 30, 2011 (JP) 2011-120684

(51) Int. Cl. H04N 13/02

(52) U.S. Cl. 348/47; 348/E13.074

(57) ABSTRACT

A 3D camera has a display processor that displays a 2D object image on a display by a 2D display process and that displays a 3D object image on the display by a 3D display process; and a position sensor that detects the position of the camera on the basis of an inclination angle from a horizontal position of the camera. Then, the display processor displays an object image as a 2D object image when the inclination angle exceeds a threshold angle in a state that an object image is displayed as a 3D image.

### BACKGROUND OF THE INVENTION

1. Field of the Invention

This invention relates to a camera that is capable of displaying a 3D image, and particularly to the capability of switching between a 2D image and a 3D image.

2. Description of the Related Art

A digital camera with a function for displaying a 3D image is equipped with a pair of imaging devices that are apart from one another by a distance based on a binocular parallax or disparity. When recording a 3D image, the camera photographs a target object by using both of the imaging devices to generate one photographic image for a left eye and one photographic image for a right eye. Then, the photographic images for left and right eyes are displayed alternately on a display unit such as an LCD, in accordance with a parallax barrier method or lenticular lens method. Thus, a stereoscopic image is displayed that affords a user a perception of the depth without polarized 3D glasses. A digital camera with such a function is also capable of recording and displaying a conventional image (hereinafter, referred to as either a “2D image” or “flat image”). In this case, one of the imaging devices is used (for example, see JPH8-317425A).

On the other hand, a 3D display unit such as a television is capable of selectively displaying a conventional 2D image and a 3D image. When displaying a 3D image, an image for the left eye and an image for the right eye are alternately displayed, as described above for the 3D camera. On the other hand, an image that is prepared for a conventional image is directly displayed (for example, see JP2010-171730A).

### SUMMARY OF THE INVENTION

An object of the present invention is to provide a 3D camera that is capable of displaying or recording a 3D image in accordance with a display state or a photographing state.

A 3D camera according to the present invention has a display processor that displays a 2D object image on a display in a 2D display mode and that displays a 3D object image on the display in a 3D display mode; and a position sensor that detects the position of the camera on the basis of an inclination angle from a horizontal position of the camera. Then, the display processor displays an object image as a 2D object image in the 3D display mode when the inclination angle exceeds a threshold angle.

A method for displaying a 3D image according to another aspect of the present invention includes: displaying a 2D object image on a display in a 2D display mode and that displays a 3D object image on the display in a 3D display mode; detecting the position of the camera on the basis of an inclination angle from a horizontal position of the camera; and displaying an object image as a 2D object image in the 3D display mode when the inclination angle exceeds a threshold angle.

A 3D camera according to another aspect of the present invention has a pair of imaging devices configured to be arranged apart from one another by a distance corresponding to a binocular disparity; a photographing processor that generates and records an image for a left eye and an image for a right eye on the basis of image-pixel signals read from the pair of imaging devices; and a position sensor that detects the position of the camera on the basis of an inclination angle from a horizontal position of the camera. Then, the photographing processor generates and records a 2D object image on the basis of one of either the image for the left eye or the image for the right eye when the inclination angle is greater than a threshold angle.

A method for photographing 3D image according to another aspect of the present invention includes: generating and recording an image for a left eye and an image for a right eye on the basis of image-pixel signals read from the pair of imaging devices, the pair of imaging devices configured to be arranged apart from one another by a distance corresponding to a binocular disparity; detecting the position of the camera on the basis of an inclination angle from a horizontal position of the camera; and generating and recording a 2D object image on the basis of one of either the image for the left eye or the image for the right eye when the inclination angle is greater than a threshold angle.

A 3D camera according to another aspect of the present invention has a pair of imaging devices configured to be arranged apart from one another by a distance corresponding to a binocular disparity; and a photographing processor that generates and records an image for a left eye and an image for a right eye on the basis of image-pixel signals read from the pair of imaging devices. Then, the photographing processor generates and records a 2D object image on the basis of one of either the image for the left eye or the image for the right eye. Also, the photographing processor switches between the generation of the 2D object image and the generation of the image for the left eye and the image for the right eye in accordance to the position of the camera.

### BRIEF DESCRIPTION OF THE DRAWINGS

The present invention will be better understood from the description of the preferred embodiments of the invention set forth below, together with the accompanying drawings, in which:

FIG. 1 is a perspective view of a digital camera according to a first embodiment;

FIG. 2 is a front view of the digital camera;

FIG. 3 is a block diagram of the digital camera;

FIG. 4 is a schematic view of the inner construction of the LCD;

FIG. 5 is a flowchart of a photographing process;

FIG. 6 is a subroutine of Step S107 in FIG. 5;

FIG. 7 is a flowchart of a photographing process according to a second embodiment; and

FIG. 8 is a flowchart of a replay process.

### DESCRIPTION OF THE PREFERRED EMBODIMENTS

Hereinafter, the preferred embodiments of the present invention are described with reference to the attached drawings.

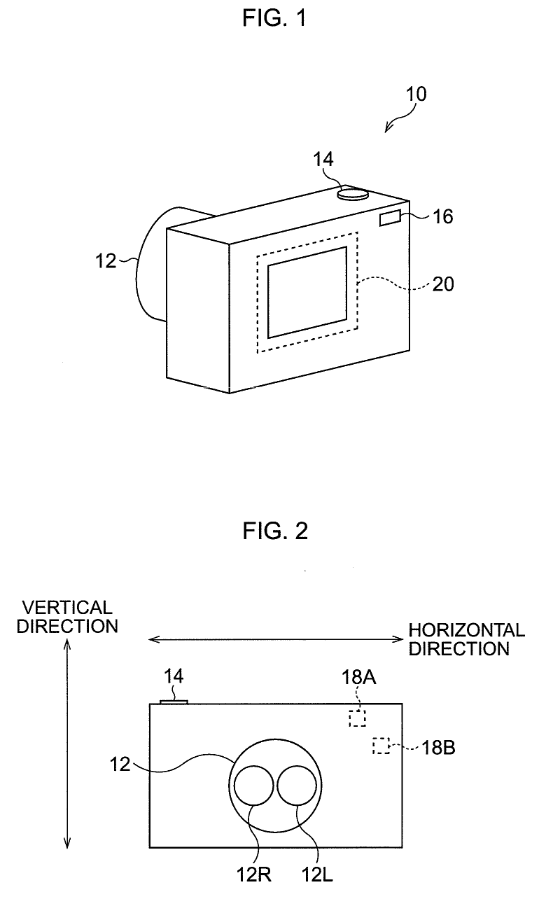

FIG. 1 is a perspective view of a digital camera according to a first embodiment. FIG. 2 is a front view of the digital camera.

The digital camera 10 is capable of recording and displaying a 3D image or stereoscopic image, and is equipped with a pair of imaging devices 12L and 12R in a lens barrel 12. A display unit 20, which is provided on the back surface of the camera 10, is herein an LCD that is capable of displaying a 3D image based on a binocular barrier method. Also, the camera 10 selectively displays a 2D image or a 3D image. Namely, a user can switch between a 2D display and a 3D display.

A mode button 16 is operated by a user when setting one mode from a series of modes including a photographing mode and a replay mode. When a main electric power button (not shown) is turned ON, the photographing mode is automatically set. Furthermore, in the photographing mode, a user selects from one of two photographing modes: a 3D photographing mode using the pair of photographing optical lenses 12L and 12R or a 2D photographing mode using one lens. In the 3D photographing mode a through-image is displayed. Then, a photographing process is carried out when a release button 14 is depressed so that a 3D image, i.e., an image for the left eye and an image for the right eye are recorded. In the 2D photographing mode, a conventional 2D image is recorded.

In the replay mode, a 3D image display mode or a 2D image (planar image) display mode can be selected. In the case of the 3D image display mode, an image selected by the user is displayed on the LCD 20 in accordance with a 3D display process.

The digital camera 10 is further equipped with position sensors 18A and 18B, which detect a position or attitude of the camera 10 by detecting an inclination angle from the horizontal position of the camera 10, i.e., the left and right directions. The position sensor 18A detects the vertical position of the camera 10, whereas the position sensor 18B detects the horizontal position of the camera 10.

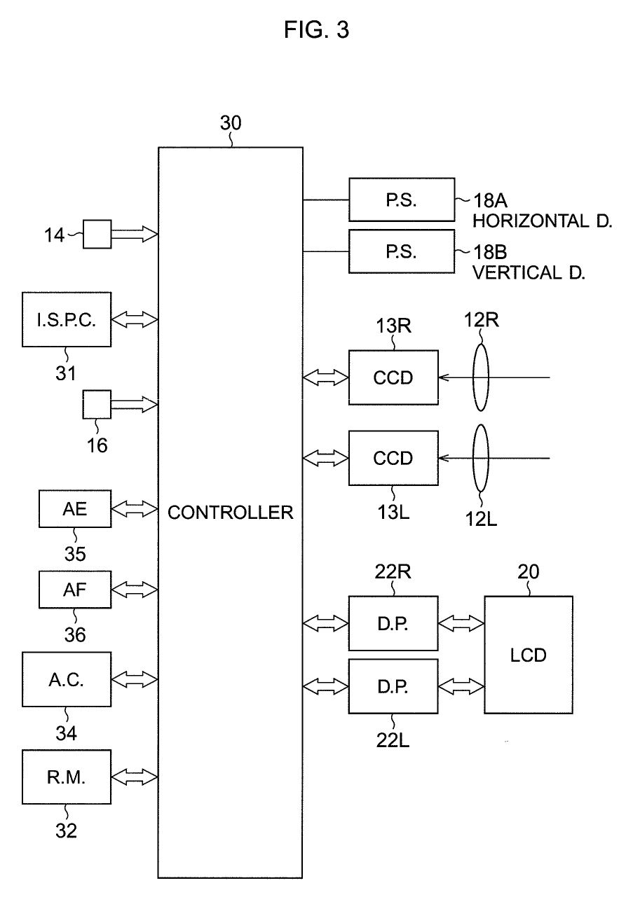

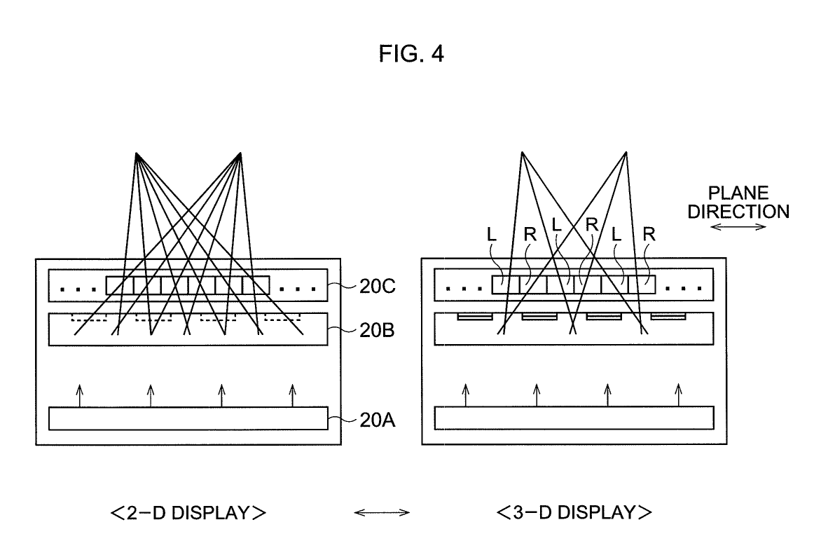

FIG. 3 is a block diagram of the digital camera 10. FIG. 4 is a schematic view of the inner construction of the LCD 20.

A controller 30 controls the camera 10 to carry out a series of photographing processes, a replay process, etc., in accordance with an operation of the release button 14 and the mode button 16. A ROM unit (not shown) in the controller 30 stores a program that controls a camera motion.

A CCD 13R configures one imaging device with the optical lens 12R. Similarly, a CCD 13L configures another imaging device with the optical lens 12L. In the 3D image photographing mode, one frame's worth of image-pixel signals are read from the CCD 13R and 13L at a given time interval (e.g., 1/60 second), respectively.

An image-signal processing circuit 31 carries out a white balance process, a color conversion process, etc., on the image-pixel signals read from the CCD 13L and CCD 13R. Consequently, image data for the left eye and image data for the right eye are generated.

Display processors 22L and 22R drive the LCD 20 on the basis of the image data for the left eye and the image data for the right eye to display a 3D image. Concretely, the image data for left eye and the image data for right eye are alternately arranged along the horizontal direction of the LCD 20. As shown in FIG. 4, the LCD 20 is equipped with a back light unit 20A, a liquid crystal switch 20B, and a TFT liquid crystal display 20C. The light crystal switch 20B, which has a plurality of liquid crystal elements, is arrayed in a direction parallel to the display surface of the LCD 20 and is switched ON and OFF to change the direction of light from the back light unit 20A.

When the liquid crystal switch 20B is turned ON, light from the image for the left eye reaches the left eye of the user, and light from the image for right eye reaches the right eye of the user. This 3D display process that directs a pair of beams of different images to different eyes allows a user to perceive a depth based on a binocular parallax. Therefore, a through-image (moving image) can be displayed stereoscopically without polarized lenses.

When the release button 14 is depressed halfway, a metering process, an exposure value computation, an aperture adjustment and a focus adjustment are carried out by an aperture controller 34, an AE (Auto Exposure) processor 35 and an AF (Auto Focus) processor 36. When the release button 14 is fully depressed, one frame's worth of image-pixel signals are generated on the CCD 13L and 13R, respectively, in accordance to a motion of a shutter (not shown). Then, the image-pixel signals read from the CCD 13L and 13R are input to the image signal processing circuit 31 to generate image data for the left eye and image data for the right eye. The generated image data are stored in a recording memory 32.

When a given recorded image is selected by the user during the replay mode, corresponding image data for the left eye and right eye are read from the recording memory 32. Then, the image data for the left eye and the image data for the right eye are alternately arrayed in the LCD 20.

On the other hand, when the 2D photographing mode is set, one of the CCDs 13L and 13R is utilized to read one frame's worth of image-pixel signals. Conventional 2D image data are then generated to display a through image. At this time, an interpolation process is carried out in the image signal processing circuit 31 to generate image data matching the screen size of the LCD 20. When the release button 14 is depressed fully, 2D image data is generated and recorded in the recording memory 32. In the replay mode, the recorded 2D image can be displayed on the LCD 20.

As described below, when the orientation of the camera 10 is changed from the horizontal position to the vertical position while a user shoots a target object, only the display processor 20R drives the LCD 20 and a 2D image is displayed in accordance to a 2D display process. Concretely, an image is arrayed for the right eye and the same image for right eye is arrayed in the place prepared for the left-eye image. Thus, a flat 2D image that does not require a binocular parallax is displayed.

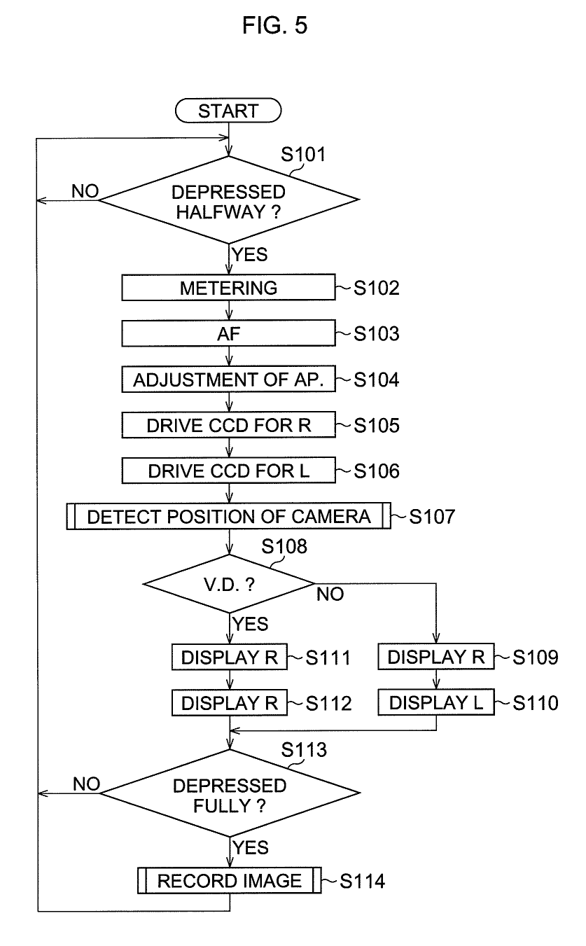

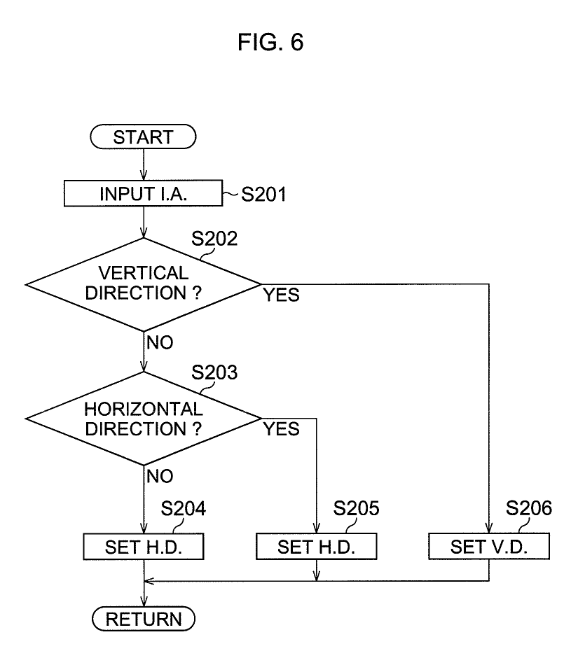

FIG. 5 is a flowchart of a photographing process. FIG. 6 is a subroutine of Step S107 in FIG. 5, which represents a flowchart of a camera position detection process. Herein, a 3D image photographing mode is set.

When the release button 14 is depressed halfway, the metering process, focus adjustment and aperture adjustment are carried out (Steps 101-104). Then, image data for the left eye and image data for the right eye are generated from image-pixel signals read from the CCDs 13L and 13R (Steps 105 and 106).

In Step S107, the position sensors 18A and 18B detect the position of the camera 10. As shown in FIG. 6, when the controller 30 detects a position signal from the position sensors 18A and 18B, a determination is made as to whether or not the camera 10 is oriented in a vertical position (S201-S203). Concretely, it is determined whether the camera is inclined from the horizontal direction (see FIG. 2) by a given angle greater than a threshold angle. Threshold angle is predetermined in accordance with a maximum angle that allows a user to perceive a stereoscopic image. Herein, the threshold angle is set to 30 degrees.

When the inclined angle is equal to or less than the threshold angle, it is determined that the camera 10 is not in a vertical position, and instead is within the range of a horizontal position (S203-S205). On the other hand, when the inclined angle is greater than the threshold angle, the camera 10 is regarded as being in a vertical or semi-vertical position.

When the camera 10 is not oriented in a vertical or semi-vertical position as shown in FIG. 2, a through image is produced from the image data generated for the left eye and image data generated for the right eye to display a 3D image (Steps 108-110). On the other hand, when it is determined that the camera 10 is oriented in a vertical or semi-vertical position, a planar image based on a 2D display process is displayed on the LCD 20 (Steps 108, 111, 112). At this time, the liquid crystal switch 20B shown in FIG. 3 is turned off.

As described above, when displaying the 3D image based on the binocular parallax, different image data for the left eye image and right eye image are arrayed alternately along the horizontal direction of the screen. Therefore, if the 3D image is rotated by 90 degrees, or close to 90 degrees, to change the orientation of a photograph, the array direction of the two images on the screen is changed from the horizontal direction to the vertical direction, which is vertical to the alignment of user's eyes. Consequently, a user cannot perceive stereoscopic images when the displayed image is oriented in the vertical direction. The present embodiment can display a planar image when the camera position is changed to a vertical position.

When the release button 14 is depressed completely, an image recording process is carried out (Steps 108-110 in FIG. 5). At this time, a 2D image or 3D image is recorded in accordance with a display state of the LCD 20. A planar image is recorded when the camera 10 is oriented in a vertical position, whereas a 3D image is recorded when the position of the camera 10 is not vertical position. Note that the recorded 2D image is an image formed by arraying alternately the same one frame's worth of image-pixel signals that are read from the CCD 13R.

In this way, in the present embodiment, the 3D camera is equipped with the position sensors 18A and 18B. During the 3D image photographing mode that displays a 3D image on the LCD 20 as a through image, the 3D display process is switched to the 2D or planer image display process when the camera position is the vertical position or semi-vertical position. Consequently, 2D image is displayed on the basis of the image-pixel signals read from the CCD 13R. Then, when the release button 14 is depressed in a state that the camera position is the vertical/semi-vertical position, an image depending upon the display method, i.e., a planer image is recorded in the recording memory 32. Note that a 2D image may be generated from image-pixel signals that are read from the CCD 13L.

Since the 2D image is displayed when a camera position is a position that a user cannot perceive the depth, the user can confirm a displayed image clearly while a through image is displayed. Furthermore, since a planer image generated by using the CCD 13R is recorded when a through image is a 2D image, a planer image is replayed in the replay mode. Thus, unnecessary 3D image display process that cannot form a 3D image is not carried out.

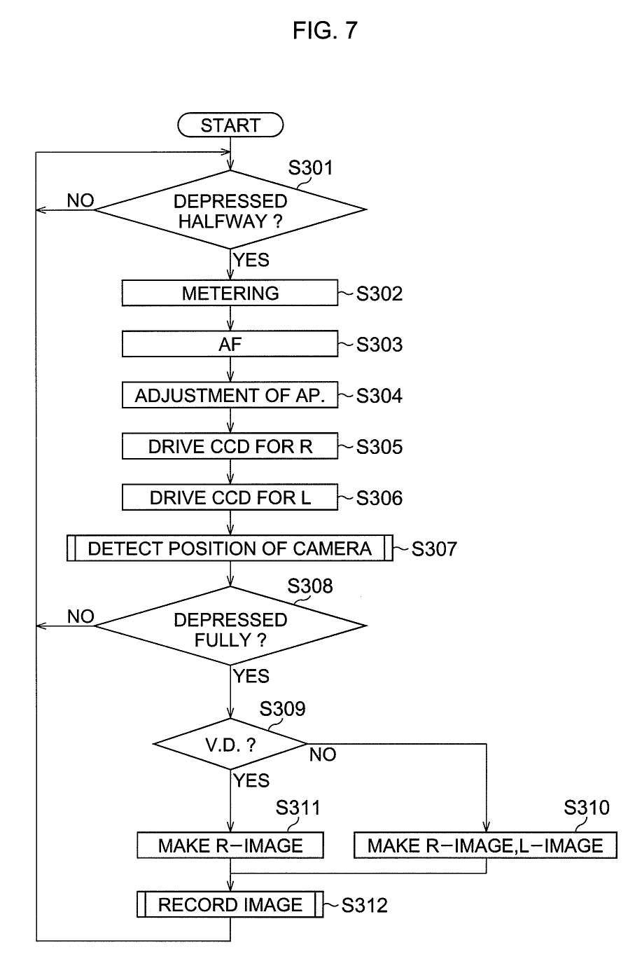

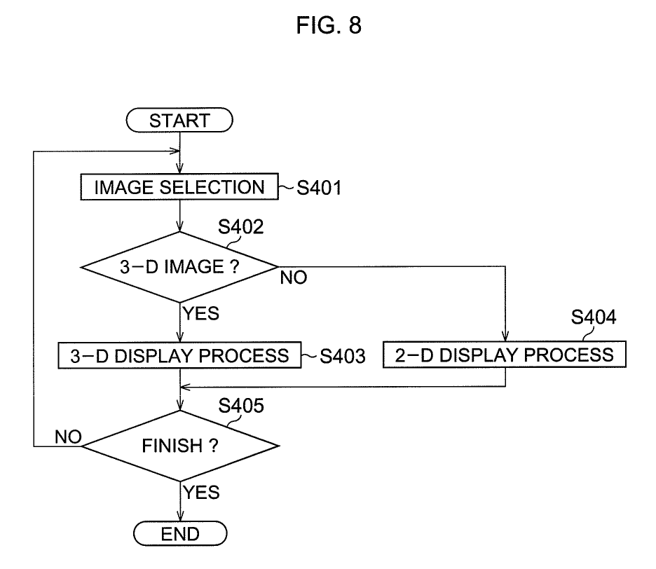

Next, a digital camera according to the second embodiment is explained with reference to FIGS. 7 and 8.

FIG. 7 is a flowchart of a photographing process according to the second embodiment.

Steps S301-S307 corresponds to Steps S101-S107 shown in FIG. 5. Note that a planar image based on image-pixel signals that are read from the CCD 13R is displayed as a through image.

When the release button 14 is fully depressed when the camera 10 is oriented in a vertical position, one frame image data is generated from one frame's worth of image-pixel signals that are generated in the CCD 13R in one exposure. The generated 2D image data is recorded. On the other hand, when the camera 10 is not oriented in a vertical position, image data for the left eye and image data for the right eye are generated on the basis of the image-pixel signals read from the CCD 13L and the CCD 13R.

FIG. 8 is a flowchart of a replay process.

When a user selects one image to be displayed from a series of recorded images, it is determined whether the selected image has been recorded as a 3D image (Steps S401 and S402). When the selected image is not a 3D image but a 2D image, a planar image that has a resolution corresponding to the screen size of the LCD 20 is displayed. At this time, an image process including an interpolation process is carried out (Step S404). On the other hand, when the selected image is recorded as a 3D image, a 3D image is displayed (S403). The operations of Steps S401-S405 are repeated until the replay mode is changed to another mode.

In this way, in the second embodiment, a 2D image or 3D image is recorded in accordance with the camera position. Especially, since the recorded image is one frame image formed by one frame's worth of image-pixel signals, which is different from the first embodiment, a more natural 2D image compared to the first embodiment is displayed.

As for the detection of the camera position, a sensor other than the position sensor may be optionally applied. Also, the switching process between a 2D image process and a 3D image process may be carried out on the basis of a maximum allowable angle within a camera position range that allows the binocular disparcity. A threshold angle other than 30 degrees may be set.

The present disclosure relates to subject matter contained in Japanese Patent Application No. 2011-120684 (filed on May 30, 2011), which is expressly incorporated herein by reference, in its entirety.

1. A 3D camera comprising:
a display processor that displays a 2D object image by a 2D display process and that displays a 3D object image by a 3D display process; and
a position sensor that detects the position of said camera on the basis of an inclination angle from a horizontal position of the camera, said display processor displaying an object image as a 2D object image when the inclination angle exceeds a threshold angle in a state that an object image is displayed as a 3D image.

2. The 3D camera of claim 1, wherein said display processor changes a 3D display process to a 2D display process to display the 2D object image in response to a vertical position of said camera.

3. The 3D camera of claim 1, further comprising:
a pair of imaging devices set apart from one another by a distance corresponding to a binocular disparity;
an image processor that generates one image for a left eye and another image for a right eye on the basis of image-pixel signals read from said pair of imaging devices, said display processor displaying a 3D object image on the basis of the image for the left eye and the image for right eye; and
a recording processor that records an object image in response to a photographing operation, said recording processor recording a 2D object image or a 3D object image in accordance to a through image that is displayed when the photographing operation is carried out.

4. The 3D camera of claim 3, wherein said display processor displays the 2D object image on the basis of one of the images for the left eye or the right eye.

5. A method for displaying a 3D image, comprising:
displaying a 2D object image on a display by a 2D display process and that displays a 3D object image on said display by a 3D display process;
detecting the position of said camera on the basis of an inclination angle from a horizontal position of the camera; and
displaying an object image as a 2D object image when the inclination angle exceeds a threshold angle in a state that an object image is displayed as a 3D image.

6. A 3D camera comprising:
a display processor that displays a 2D object image on a display by a 2D display process and that displays a 3D object image on said display by a 3D display process; and
a position sensor that detects the position of said camera on the basis of an inclination angle from a horizontal position of the camera, said display processor switching between the 2D display process and the 3D display process in response to the position of said camera.

7. A 3D camera comprising:
a pair of imaging devices configured to be arranged apart from one another by a distance corresponding to a binocular disparity;
a photographing processor that generates and records an image for a left eye and an image for a right eye on the basis of image-pixel signals read from said pair of imaging devices; and
a position sensor that detects the position of said camera on the basis of an inclination angle from a horizontal position of the camera, said photographing processor generating and recording a 2D object image on the basis of one of either the image for the left eye or the image for the right eye when said inclination angle is greater than a threshold angle.

8. A method for photographing 3D image, comprising:
generating and recording an image for a left eye and an image for a right eye on the basis of image-pixel signals read from said pair of imaging devices, said pair of imaging devices configured to be arranged apart from one another by a distance corresponding to a binocular disparity;
detecting the position of said camera on the basis of an inclination angle from a horizontal position of the camera; and
generating and recording a 2D object image on the basis of one of either the image for the left eye or the image for the right eye when said inclination angle is greater than a threshold angle.

9. A 3D camera comprising:
a pair of imaging devices configured to be arranged apart from one another by a distance corresponding to a binocular disparity; and
a photographing process or that generates and records an image for a left eye and an image for a right eye on the basis of image-pixel signals read from said pair of imaging devices, said photographing processor generating and recording a 2D object image on the basis of one of either the image for the left eye or the image for the right eye, said photographing processor switching between the generation of the 2D object image and the generation of the image for the left eye and the image for the right eye in accordance to the position of said camera.
